(19) United States
(12) Patent Application Publication
(10) Pub. No.: US 2018/0189809 A1
(43) Pub. Date: Jul. 5, 2018

(54) ACCOUNT LEVEL TRIGGERS

(71) Applicant: Marketo, Inc., San Mateo, CA (US)

(72) Inventor: Mahesh Jeswani, San Mateo, CA (US)

(21) Appl. No.: 15/394,646

(22) Filed: Dec. 29, 2016

(51) Int. Cl. G06Q 30/02; G06Q 40/00

(52) U.S. Cl. CPC G06Q 30/0203; G06Q 40/12

(57) ABSTRACT

A method and system for account level triggers are described. An automation management system aggregates marketing-relevant activities performed by potential customers across a variety of marketing channels. The leads are matched to marketing accounts, and alerts are sent to account managers when customized trigger conditions are met, generally indicating that a time-sensitive marketing opportunity exists or that recent marketing efforts are having no effect. Triggers can be created based on a weighted account score compiled from multiple marketing dimensions. Triggers can be set to notify account managers when the account score changes more than some programmed thresholds for value and time.

### TECHNICAL FIELD

Examples described herein relate to software as a service automation, and more specifically, to a system and method for cross-channel marketing account level triggers.

### BACKGROUND

Marketing automation is a category of technology that allows companies to streamline, automate, and measure marketing tasks and workflows so they can increase operational efficiency and grow revenue faster. Marketing automation helps marketers streamline their lead generation, segmentation, lead nurturing and lead scoring, customer lifecycle marketing, cross-sell and up-sell, customer retention, and marketing return on investment measurement. It allows marketers to integrate marketing initiatives and keep track of leads as they progress through the marketing funnel.

Account-based marketing (ABM) is a strategic approach to business marketing in which an organization considers and communicates with individual prospect or customer accounts as markets of one. Account-based marketing is typically employed in enterprise level sales organizations and business to business (B2B) marketing.

B2B marketers often try to cast a very wide net with their marketing campaigns in hopes of appealing to as many companies as possible in their target market. ABM is an alternative B2B strategy that concentrates sales and marketing resources on a clearly defined set of target accounts within a market and employs personalized campaigns designed to resonate with each account. With ABM, a marketing message is based on the specific attributes and needs of the account targeted, hence the name account-based marketing.

### BRIEF DESCRIPTION OF THE DRAWINGS

FIG. 1 illustrates an example automation management system that manages cross-channel account level triggers, in accordance with some aspects.

FIG. 2 describes an example method of cross-channel account level triggering, in accordance with some aspects.

FIG. 3 illustrates a sample interface for managing account level triggers, in accordance with some aspects.

FIG. 4 illustrates a sample interface for managing account level trigger alerts, in accordance with some aspects.

FIG. 5 illustrates example computer systems for an automation management system in communication with other networked systems.

FIG. 6 illustrates a computer system upon which aspects described herein may be implemented.

### DETAILED DESCRIPTION

According to examples, an automation management system is provided for aggregating marketing-relevant activities performed by potential customers (i.e., leads) across a variety of marketing channels. The leads are matched to marketing accounts (typically a company), and alerts are sent to account managers when customized trigger conditions are met, generally indicating that a time-sensitive marketing opportunity exists or that recent marketing efforts are having no effect.

In some aspects, triggers are created based on a weighted account score compiled from multiple marketing dimensions. Triggers can be set to notify account managers when the account score changes more than some programmed thresholds for value and time. In other aspects, an alert is sent when specific channel activity takes place according to programmed rules.

Among other features, the provided automation management system implements account-based marketing (ABM). ABM entails personalizing messaging and communications to specific accounts so that marketing campaigns resonate with these target audiences. Targeted customers are more likely to engage with content that is geared specifically to them and is relevant to their business and stage in the buyer journey. Because ABM is so targeted, it allows marketers to focus their resources efficiently and run marketing programs that are specifically optimized for target accounts. ABM is one of the most efficient ways to align sales and marketing. This is primarily due to the fact that the marketer running an ABM program operates with a mindset very similar to sales—thinking in terms of accounts and how to target them, bring them to the table, and generate revenue from them.

Unlike more passive advertising strategies, the individualized nature of ABM creates time-sensitive opportunities and allows marketers to take advantage of these opportunities. Among other benefits, account level triggers provide real-time notifications of events that allow account managers to take immediate action in time-sensitive situations where a potential sale may be lost otherwise. Customizable triggers allow account managers to set their own criteria based on the particulars of each account rather than a one size fits all policy.

Conventional account scoring techniques used with ABM score accounts based on single dimensions such as demographics. In contrast, the cross-channel account scoring that the automation management system provides can calculate scores based on multiple criteria and dimensions, and therefore implements a holistic approach compared to solutions that can miss the big picture. Among other benefits, these technical solutions enable the automation management system to identify urgency, alert marketers based on this urgency, and provide marketers with additional information to help sell products better. For example, knowing that multiple stakeholders from a company (e.g. people with certain job titles or ranks) have been visiting web pages showing interest in a given product allows a marketer to tailor messages and increase the likelihood of making a sale. Therefore, the provided automation management system can make decisions based on aggregated information at an account level which are not possible in conventional systems.

In implementing ABM, technology becomes essential with any scale and with the increasing number of channels marketers are required to manage. Keeping track of hundreds of thousands, or even millions, of leads and the individual actions taken with each of those leads to understand how marketing spend influenced those leads that led to a sales opportunity is not feasible without technical solutions to manage this level of volume. An individual sales opportunity may take months to develop, often through interactions with different staff members. Even if they were to record that information, organizing it to track individual sales, and to present it in a meaningful way, would be an insurmountable burden with limited resources. However, this information would be valuable to marketing executives looking to show a return on investment on the marketing budget in terms of tangible sales data. Without them, management have to justify marketing spending based on aggregated marketing budget and aggregated sales.

One or more aspects described herein provide that methods, techniques and actions performed by a computing device are performed programmatically, or as a computer-implemented method. Programmatically means through the use of code, or computer-executable instructions. A programmatically performed step may or may not be automatic.

One or more aspects described herein may be implemented using programmatic modules or components. A programmatic module or component may include a program, a subroutine, a portion of a program, a software component, or a hardware component capable of performing one or more stated tasks or functions. In addition, a module or component can exist on a hardware component independently of other modules or components. Alternatively, a module or component can be a shared element or process of other modules, programs or machines.

Furthermore, one or more aspects described herein may be implemented through the use of instructions that are executable by one or more processors. These instructions may be carried on a computer-readable medium. Machines shown or described with figures below provide examples of processing resources and computer-readable media on which instructions for implementing some aspects can be carried and/or executed. In particular, the numerous machines shown in some examples include processor(s) and various forms of memory for holding data and instructions. Examples of computer-readable media include permanent memory storage devices, such as hard drives on personal computers or servers. Other examples of computer storage media include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

System Overview

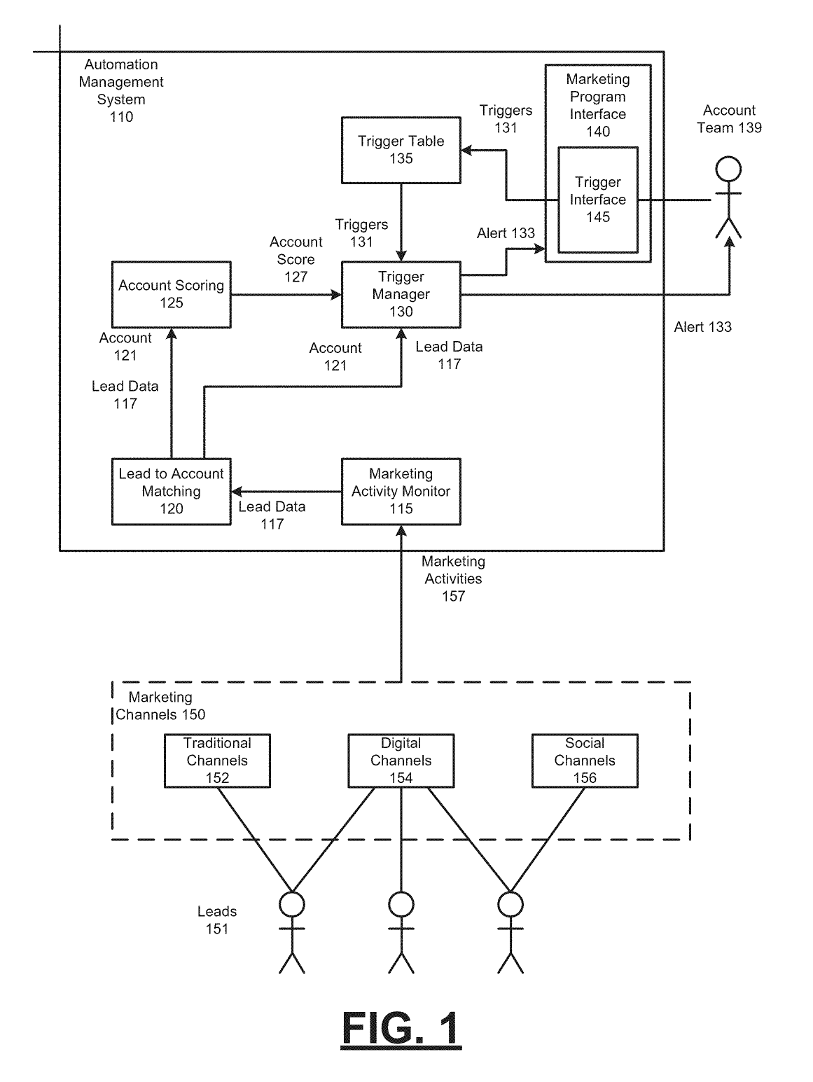

FIG. 1 illustrates an example automation management system 110 that manages cross-channel marketing account level triggers, in accordance with some aspects. The automation management system 110 monitors activities from potential customers, known as leads 151, matches the leads 151 to appropriate marketing accounts in an account-based marketing system, determines whether the leads' activities satisfy the criteria for any programmed triggers 131, and sends alerts to marketers for the associated marketing account.

In some aspects, the automation management system 110 includes a marketing activity monitor 115, lead to account matching 120, account scoring 125, trigger manager 130, trigger table 135, marketing program interface 140, and trigger interface 145. In addition, an example automation management system 110 can include other components and functionality not illustrated for the sake of simplicity.

The marketing activity monitor 115 listens for marketing activities 157 that leads 151 perform on various marketing channels 150. Leads 151 are people or companies who may have an interest in a firm's products or services. Marketing departments receive new leads 151 through marketing activities 157 such as website visits, online or traditional advertisements, webinars, and other marketing campaigns. Depending on the reach of these marketing campaigns, millions of leads 151 may be generated through different marketing channels 150.

Management of the large quantity of leads 151 includes tracking the leads 151, identifying high-quality leads 151 to pass on to sales departments, and identifying potential customers to nurture, among other examples. Management of leads 151 can be extremely time-consuming and difficult due to the sheer volume of leads 151, subjective valuations of each lead, and the fact that only a small number of the leads 151 represent people or companies with a genuine intent to purchase. Furthermore, the lifecycle of a successful lead that generates a sale, and ultimately revenue, spans across both the marketing and sales departments. As a result, efficient management of leads 151 over their lifecycle is also important to the sales department.

An automation management system 110 helps an account team 139 manage a large quantity of leads 151. In some examples, the account team 139 includes a sales team, customer success managers, sales development managers, and other marketers. In some examples, a lead goes through a sequence of stages before resulting in a purchase. From a firm's perspective, a lead first makes itself known to the firm. Marketing staff may send emails, make phone calls, invite leads 151 to webinars or road shows, and conduct other various marketing activities 157 to engage and nurture the lead to a point where they are ready to make a purchase within a short period of time. The lead is then transitioned to the sales department. Sales representatives contact the lead to determine whether there is a genuine intent to purchase. If so, the lead is transitioned to a sales accepted opportunity stage. When a purchase or sale is completed, the lead transitions to a customer stage.

The sequence of stages that leads 151 go through forms the revenue cycle of a firm. Marketing and sales departments segment leads 151 based on stages in the revenue cycle so that leads 151 in different stages are able to receive different levels of attention and treatment. The revenue cycle concept grows out of sales cycle and marketing cycle concepts and is adopted by firms that seek to streamline activities and management in marketing and sales departments for superior revenue generations. Existing types of revenue cycle concepts in marketing/sales practices simply combine the marketing and sales cycles. As a result, they are visualized as a funnel of stages.

Even a medium-sized company could get millions of leads 151 through different marketing channels 150. The management of this large body of leads 151—to keep track of them, to identify the potential customers to nurture, to identify the high-quality ones as opportunities, among other activities—is extremely time-consuming and difficult. To keep track of all the interactions and associations between them and the opportunities is even more challenging. Marketing activities 157 associated with the leads 151 include marketing actions as well as actions taken by sales staff—i.e., sales emails, phone calls, online meeting, demos, customer visits, etc. They also include activities originated by the leads 151 themselves, such as web site visits and form fill-outs, both before and after the leads 151 reach the opportunity stage.

For each lead, marketing activities 157 can be limited to a single marketing channel 150 or occur across multiple marketing channels 150 over a period of time. Leads 151 can interact with and perform marketing activities 157 on various different types of channels, such as traditional channels 152, digital channels 154, and social channels 156.

Traditional channels 152 can include live events, such as trade shows, demonstrations, in-store advertising, telephone calls, etc. They can also include print media, radio, and television advertising. When leads 151 interact with these channels, they can provide personal details by filling out forms or making a phone call to the firm to inquire about further information.

Digital channels 154 include channels such as websites, emails, and interactions performed through mobile applications. For example, leads 151 can visit a firm's website and browse products, fill out forms requesting more information, sign up for email newsletters, or click on in-app mobile advertisements.

Social channels 156 include social media networks used for communication, professional networking, and blogging. In many of these social media networks, user interactions are logged and stored in associated with the leads 151.

In some aspects, forms that leads 151 fill out, details recorded during phone calls, and online interactions are provided directly to the marketing activity monitor 115 as marketing activities 157. For example, a firm's website can include a script to log marketing activities 157 and send them to the marketing activity monitor 115. In other aspects, the data that comprises marketing activities 157 are first entered into other databases such as customer relationship management (CRM) systems and then imported into the automation management system 110 through one or more interfaces (not illustrated). In either case, the marketing activity monitor 115 receives data for marketing activities 157 from the various marketing channels 150 in real time as those data become available.

In recent years, sales and marketing departments have migrated to automated marketing/sales platforms to track leads 151, opportunities, and accounts, as well as interactions that are associated with these entities. In some examples, an account refers to a company, which could have multiple leads 151 that are captured by the firm's marketing system. An account could also have many sales opportunities, including an initial sales opportunity, an upsell/cross-selling opportunity, and the like. Since a lead is frequently attached to accounts, especially in enterprise sales, marketing activities 157 are also likely associated with accounts. Thus, the marketing activity monitor 115 can aggregate marketing activities 157 performed by the leads 151 across any number of different types of marketing channels 150 for a marketing account or set of accounts that the account team 139 sets up through the automation management system 110.

The marketing activity monitor 115 processes marketing activities 157 and sends lead data 117 to a lead to account matching 120 component. Lead to account matching 120 uses the lead data 117 to determine an associated marketing account 121 that the lead who performed the marketing activity belongs to. In some examples, lead data 117 comprises attributes from the lead's interaction with one of the marketing channels 150. These attributes can include technical details of the interaction such as an IP address for the lead's computer when accessing a website, a domain name associated with that IP address, and location for the lead. Some of these attributes can be included in the lead data 117 itself, and other attributes can be determined through cross-referencing databases and performing searches using services built into automation management system 110 or provided by third parties. Lead data 117 can also include information that the lead provides. For example, a lead may submit a company email address on a form or tell an operator the name of the company the lead works for over the telephone.

In some examples, the company the lead represents is the marketing account 121. However, a company can be divided into more than one account depending on the account team 139 preferences and configurations. For example, the account team 139 may divide a large enterprise into separate regional accounts or accounts based on the particular product or service a division of the company provides. Therefore, the account 121 might only include leads 151 for one office or department of a company. In addition, accounts can be grouped together into account segments such as the manufacturing industry or telecommunications industry.

Once an account 121 is identified, lead to account matching 120 sends the account 121 and lead data 117 to an account scoring 125 component and a trigger manager 130. Account scoring 125 updates an account score 127 for the account 121 and provides the updated account score 127 to the trigger manager 130.

Account scoring is a systematic approach to help sales and marketing teams identify and prioritize companies including leads 151 that are prospects or customers most likely to buy. Account scoring 125 uses lead data 117 from the multiple marketing channels 150 to assign a numerical account score 127 that represents the potential value to the firm for the account 121. In some aspects, the account score 127 is a combination of many different dimensions, each of which can be scored individually and weighted. For example, account scoring 125 can generalize the account score 127 into data relating to the market fit of the account 121 for the firm, the buying strength of the account 121, buyer engagement, and external signals. Account scoring 125 can weight each of these dimensions based on customizable settings from the account team 139 to calculate an overall account score 127 for the account 121. Account scoring 125 can then provide this account score 127 to a trigger manager 130.

The trigger manager 130 monitors account metrics or events for each of the marketing accounts that account team 139 manages and sends notifications to account team 139 when programmed conditions attached to triggers 131 are met. Triggers 131 are generally set up to notify account team 139 that a time-sensitive marketing opportunity exists or that recent marketing efforts are having no effect. For example, an account team 139 can create a trigger 131 for the trigger manager 130 to send an alert 133 when certain marketing activities 157 or the account score 127 exceeds a threshold.

In some aspects, the trigger manager 130 uses the lead data 117 associated with the marketing account 121 to determine whether to send an alert 133 to the account team 139. The trigger manager 130 retrieves a list of triggers 131 active for the account 121 from a trigger table 135 and determines whether the assigned criteria for any of the triggers 131 are met based on the lead data 117. Some examples of triggers 131 are if a number of participant registrations for an event exceed 100, if more than three vice president or higher level executives express interest in a product or service, or if activity across multiple marketing channels 150 increases 10% or more. In addition, members of account team 139 can create triggers 131 based on account score 127. For example, an account team 139 may create a trigger to send an alert 133 if the account score 127 for the account 121 is above 90 or if the account score 127 has increased by 10% or more over the last seven days.

The automation management system 110 stores records of lead data 117 and metrics associated with each account 121 in order for the trigger manager 130 to determine whether the criteria for triggers 131 are met. Account metrics include data from marketing activities 157 for specific marketing channels 150 and aggregations of data from multiple channels. Examples of metrics are numbers of lead interactions with each marketing channel 150 over periods of time, information from lead data 117 such as a lead's role in a company, and account score 127.

If each of the constraints specified for one of the triggers 131 are met, the trigger manager 130 transmits an alert 133 to an account team 139. Due to the possible urgency of the marketing opportunity, an alert 133 is generally a real-time notification sent directly to the account team 139, such as an email, text message, automated phone call, mobile application notification, etc. In some examples, the alert 133 can provide the account team 139 with the account 121, which of the triggers 131 were met, and other details included in the lead data 117 or associated with the account 121 such as contact information for leads 151. In situations where a firm has multiple account owners for a given account 121, the trigger manager 130 can send the alert 133 to each of the account owners in accordance with preferences set for the account 121 or for the firm in general.

In addition, the trigger manager 130 can send the alert 133 to multiple locations, including a marketing program interface 140, which can list each of the triggers 131 for the accounts 121 and provide further details such as the account score 127 and metrics. The marketing program interface 140 can prominently display any alerts 133 that have been triggered so that the account team 139 sees the alerts 133 upon accessing the automation management system 110.

In some implementations, the automation management system 110 can also modify or select content to transmit or display to the leads 151 in response to trigger conditions being met. For example, if multiple leads 151 associated with the same account 121 engage with a marketing campaign for a particular product, the automation management system 110 can display online advertising related to that product for leads 151 that are matched to the account 121. As another example, the automation management system 110 can contact leads 151 through alternate marketing channels 150 such as email or a phone call.

An account team 139 can access a trigger interface 145 on the marketing program interface 140 to create, edit, and delete triggers 131. The account team 139 can set various parameters and constraints for each trigger, including criteria such as a magnitude of change in an account metric, thresholds, a moving window of time, etc. The account team 139 can also perform management tasks on triggers 131 such as naming and renaming, enabling/disabling, and assigning which of the triggers 131 apply to a given account or account segment. In some examples, the marketing program interface 140 is part of a web-based service and the account team 139 interacts with the interfaces through a web browser on a user device. In other examples, the marketing program interface 140 exists as part of a standalone program that runs on the user device and communicates over a network with the automation management system 110. Any new triggers 131 or updates made to existing triggers 131 are saved in the trigger table 135.

Methodology

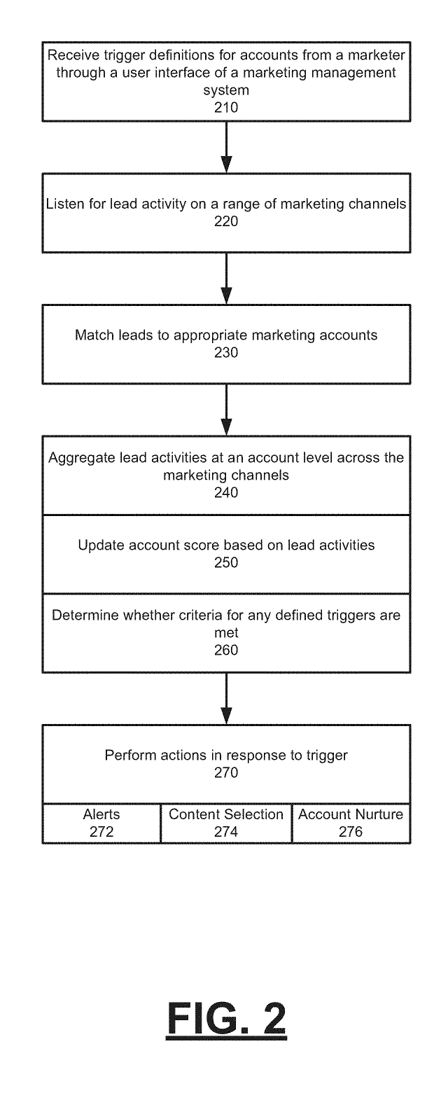

FIG. 2 describes an example method of cross-channel account level triggering, in accordance with some aspects. While operations of the method are described below as being performed by specific components, modules or systems of automation management system 110, it will be appreciated that these operations need not necessarily be performed by the specific components identified, and could be performed by a variety of components and modules, potentially distributed over a number of machines. Accordingly, references may be made to elements of automation management system 110 for the purpose of illustrating suitable components or elements for performing a step or sub step being described. Alternatively, at least certain ones of the variety of components and modules described in system 100 can be arranged within a single hardware, software, or firmware component. It will also be appreciated that some of the steps of this method may be performed in parallel or in a different order than illustrated.

In some aspects, an automation management system 110 receives trigger definitions for marketing accounts in an account-based marketing paradigm. A marketer, such as an account owner, manager, or administrator, enters the trigger definitions through a user interface of the automation management system 110 (210). In other implementations, the marketer can transmit the trigger definitions through an application program interface or batch process from a user device. The trigger definitions include one or more criteria acting as constraints that a trigger manager uses to determine when to trigger an alert.

As leads interact with a variety of marketing channels, a marketing activity monitor listens for lead activity on the channels (220). These marketing channels can include traditional channels, such as live events, print media, and television, digital channels, such as websites, email, and mobile applications, and social media channels. For each lead, their marketing activities can be limited to a single marketing channel or occur across multiple marketing channels over a period of time.

In some aspects, forms that leads fill out, details recorded during phone calls, and online interactions are provided directly to the marketing activity monitor. For example, a firm's website can include a script to log marketing activities and send them to the marketing activity monitor. In other aspects, the data that comprises the marketing activities are first entered into other databases such as customer relationship management (CRM) systems and then imported into the automation management system through one or more interfaces. In either case, the marketing activity monitor receives data for marketing activities from the various marketing channels in real time as those data become available.

The marketing activity monitor processes marketing activities and sends lead data to a lead to account matching component. The lead to account matching uses the lead data to determine an associated marketing account that the lead who performed the marketing activity belongs to (230). In some examples, lead data comprises attributes from the lead's interaction with one of the marketing channels. These attributes can include technical details of the interaction such as an IP address for the lead's computer when accessing a website, a domain name associated with that IP address, and location for the lead. Some of these attributes can be included in the lead data itself, and other attributes can be determined through cross-referencing databases and performing searches using services built into automation management system 110 or provided by third parties. Lead data can also include information that the lead provides. For example, a lead may submit a company email address on a form or tell an operator the name of the company the lead works for over the telephone.

The automation management system 110 further aggregates lead activities at an account level across the marketing channels (240). The marketing activities can include a first activity on a first marketing channel and a second activity on a second marketing channel different from the first marketing channel. The automation management system 110 stores records of lead data and metrics associated with each account in order for the trigger manager to determine whether the criteria for triggers are met. Account metrics include data from marketing activities for specific marketing channels and aggregations of data from multiple channels. Examples of metrics are numbers of lead interactions with each marketing channel over periods of time, information from lead data such as a lead's role in a company, and an account score.

Based on the aggregation of lead activities, the automation management system 110 can update an account score for a marketing account (250). Account scoring uses lead data from the multiple marketing channels to assign a numerical account score that represents the potential value to the firm for the account. In some aspects, the account score is a combination of many different dimensions, each of which can be scored individually and weighted. For example, account scoring can generalize the account score into data relating to the market fit of the account for the firm, the buying strength of the account, buyer engagement, and external signals. Account scoring can weight each of these dimensions based on customizable settings from the marketer to calculate an overall account score for the account. Account scoring can additionally provide this account score to the trigger manager as a metric for the account.

In some aspects, the automation management system 110 periodically checks to determine whether criteria for any defined triggers are met (260). A trigger manager retrieves a list of triggers active for the account from a trigger table and determines whether the assigned criteria for any of the triggers are met based on the lead data. Some examples of triggers are if a number of participant registrations for an event exceed 100, if more than three vice president or higher level executives express interest in a product or service, or if activity across multiple marketing channels increases 10% or more. In addition, marketers can create triggers based on account scores. For example, a marketer may create a trigger to send an alert if the account score for account is above 90 or if the account score has increased by 10% or more over the last seven days.

If each of the constraints specified for one of the triggers are met, the trigger manager can perform actions in response to the trigger (270). In some aspects, the trigger manager transmits an alert to a marketer (272). Due to the possible urgency of the marketing opportunity, an alert is generally a real-time notification sent directly to the marketer, such as an email, text message, automated phone call, mobile application notification, etc. In some examples, the alert can provide the marketer with the account, which of the triggers were met, and other details included in the lead data or associated with the account such as contact information for leads. In situations where a firm has multiple account owners for a given account, the trigger manager can send the alert to each of the account owners in accordance with preferences set for the account or for the firm in general.

In some implementations, the automation management system 110 can also modify or select content to transmit or display to the leads in response to trigger conditions being met (274). For example, if multiple leads associated with the same account engage with a marketing campaign for a particular product, the automation management system 110 can display online advertising related to that product for leads that are matched to the account. As another example, the automation management system 110 can contact leads through alternate marketing channels such as email or a phone call. Furthermore, the automation management system 110 can perform actions to nurture the account (276). For example, the automation management system 110 can send an email to the lead or contact the lead through other means until the account the lead belongs to starts showing intent to buy.

User Interface Examples

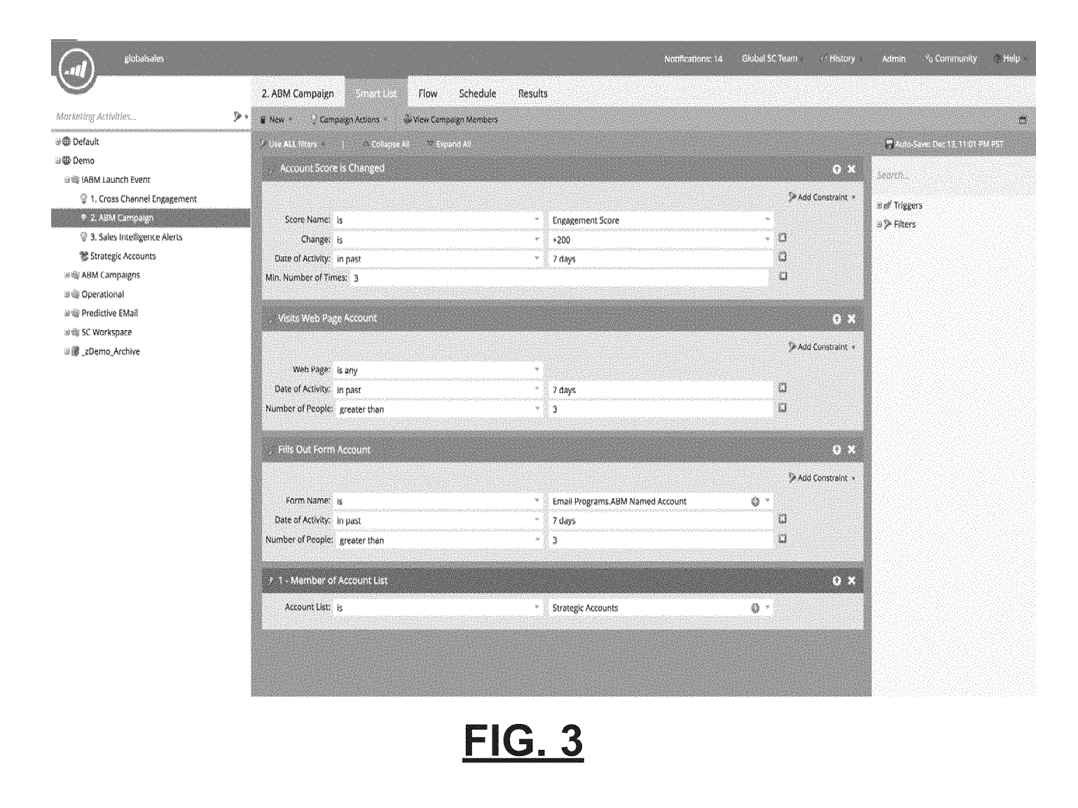

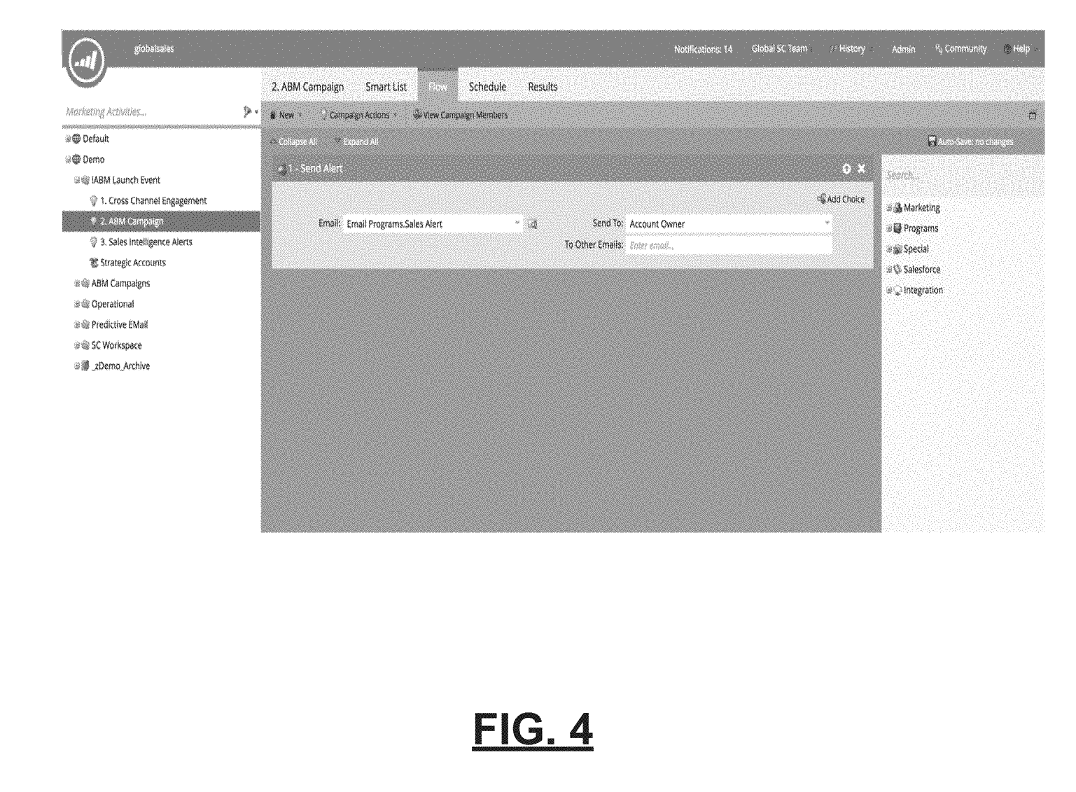

FIG. 3 illustrates a sample interface for managing account level triggers, in accordance with some aspects. FIG. 4 illustrates a sample interface for managing account level trigger alerts, in accordance with some aspects. With reference to FIG. 1, the user interfaces illustrated in FIGS. 3 and 4 are examples of the trigger interface 145 within the marketing program interface 140.

FIG. 3 illustrates three example triggers with their corresponding criteria for being activated. A marketer with access to the automation management system can access this trigger interface to create, edit, and delete triggers as shown. The marketer can set various parameters and constraints for each trigger, including criteria such as a magnitude of change in an account metric, thresholds, a moving window of time, etc. The account owner can also perform management tasks on triggers such as naming and renaming, enabling/disabling, and assigning which of the triggers apply to a given account or account segment.

The top example trigger illustrated in FIG. 3, named “Account Score is Changed,” includes four constraints that comprise the criteria for the trigger. The trigger is based on the value of the Score Name “Engagement Score,” which is one of the dimensions of the overall account score for the account. In order to satisfy the criteria for the trigger, the Engagement Score must have increased 200 points in the past 7 days. In addition, this score change needs to occur a minimum of three times to satisfy the final constraint.

The middle example trigger illustrated in FIG. 3, named “Visits Web Page Account,” includes three constraints. If any web page belonging to the account is accessed by more than three separate people (e.g., leads, opportunities, or customers) within the past 7 days, this trigger is activated.

The bottom example trigger illustrated in FIG. 3, named “Fills Out Form Account,” also includes three constraints. If more than three people fill out the form “Email.Programs.ABM Named Account” times within the past 7 days, this trigger is activated.

In some aspects, the trigger interface can also support the creation of filters, as illustrated in FIG. 3. In this example, the filter “1—Member of Account List” acts to apply the listed triggers to only the accounts that are included on the Strategic Accounts list.

Upon all of the constraints for one of the triggers being met within an account, the automation management system sends an alert to the marketers specified to receive alerts for that account. As illustrated in FIG. 4, a marketer with access to the automation management system can access this trigger interface to set the recipients of any triggered account alerts and the form of the alert. In the example shown, the automation management system is set to send an email using the template Email.Programs.Sales Alert to the account owner for the account when an alert is triggered. In some implementations, the email template can provide the account owner with information such as the name of the account that triggered the alert, which trigger was met, account scores and metrics, contact information for the people that satisfied the criteria for the trigger, etc.

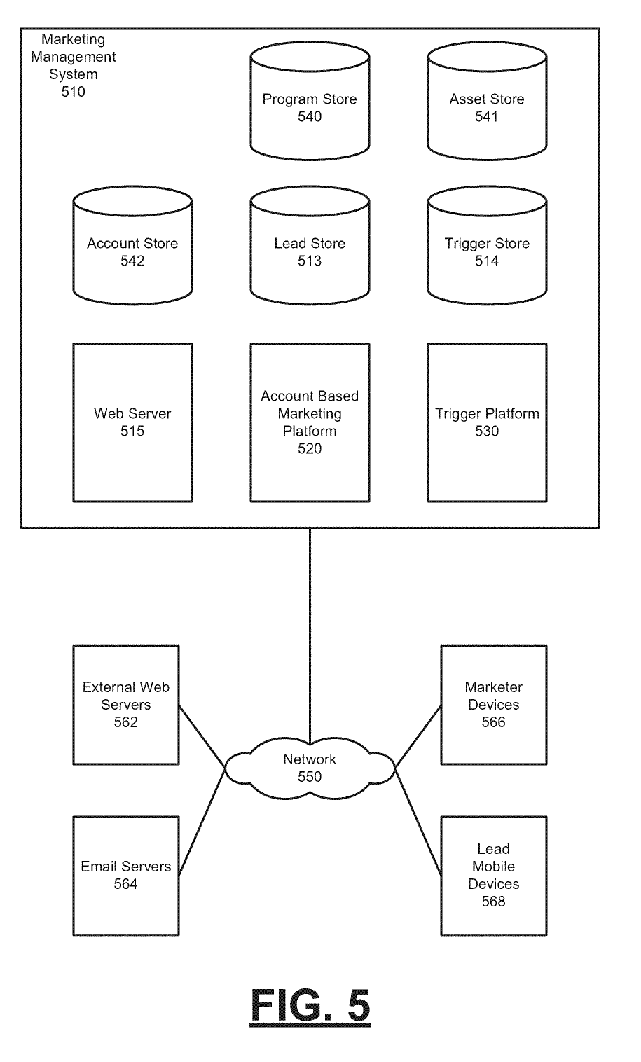

FIG. 5 illustrates example computer systems for an automation management system 510 in communication with other networked systems such as external web servers 562, email servers 564, marketer devices 566, and lead mobile devices 568.

User devices, including marketer devices 566 and lead mobile devices 568, comprise one or more computing devices that can receive user input and can transmit and receive data via the network 550. In one aspect, a user device is a conventional computer system executing, for example, a Microsoft Windows-compatible operating system (OS), Apple OS X, and/or a Linux distribution. In another aspect, the user device can be a device having computer functionality, such as a personal digital assistant (PDA), mobile telephone, smart-phone, etc. The user device is configured to communicate via network 550. The user device can execute an application, for example, a browser application that allows a user of the user device to interact with the automation management system 510. In another aspect, the user device interacts with the automation management system 510 through an application programming interface (API) that runs on the native operating system of the user device, such as iOS and ANDROID.

In one aspect, the network 550 uses standard communications technologies and protocols. Thus, the network 550 can include links using technologies such as Ethernet, 802.11, worldwide interoperability for microwave access (WiMAX), 3G, 4G, CDMA, digital subscriber line (DSL), etc. Similarly, the networking protocols used on the network 550 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 550 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

The web server 515 links the automation management system 510 via the network 550 to one or more user devices; the web server 515 serves web pages, as well as other web-related content, such as Java, Flash, XML, and so forth. The web server 515 may provide the functionality of receiving and routing messages between the automation management system 510 and the user devices, for example, instant messages, queued messages (e.g., email), text and SMS (short message service) messages, or messages sent using any other suitable messaging technique. The user can send a request to the web server 515 to upload information, for example, images or videos that are stored in an asset store 541. In addition, the user can enter marketing program data into the automation management system 510 through the web server 515 to be stored in a program store 540. Asset store 541, program store 540, and other stores can be implemented as one or more relational databases, collections of structured files such as XML files, flat plain text files, or any other method of data storage. In some aspects, automation management system 510 is a software as a service (SaaS) platform that users access through the web server 515. Additionally, the web server 515 may provide API functionality to send data directly to native user device operating systems, including iOS, Android, webOS, and Windows, among others.

An account-based marketing platform 520 receives information about interactions with leads performed by marketing staff or other users of the automation management system 510. Such information may include call records to leads, emails directed to leads, indications that emails were opened by leads, indications that emails were viewed but not opened, indications that leads were converted from prospects, indications that leads signed up for webinars, indications that leads downloaded documentation about products, indications that leads were converted into newly created opportunities, opening opportunities, closing opportunities, indications of a lead downloading a whitepaper from the vendor's website, a lead opening an email from a sales representative, a lead attending a webinar, webpage visits, form fill-outs, tradeshows, email interactions, marketing program/campaign successes and so on. This information may be gathered from an external sales platform as well as external web servers 562, which may include customer relationship management (CRM) systems.

In one aspect, the information may be manually inputted into the automation management system 510 through a user interface. In another aspect, the information about marketing activity may be gathered by the automation management system 510 through application programming interface (API) calls to external web servers 562. In a further aspect, the automation management system 510 can use a SOAP (Simple Object Access Protocol) or REST (REpresentation State Transfer) API to receive the information. In a further aspect, web pages served by external web servers 562 can include programming (e.g., JavaScript code embedded in the HTML) that transmits the information back to the automation management system 510. Email servers 564 can be configured to transmit information about lead interactions with email messages back to the automation management system 510. Lead details and relevant data and metadata regarding the leads are stored in a lead store 513 with the automation management system 510.

The account-based marketing platform 520 further operates to match leads to a marketing account using the received information about the interactions with the leads. Lead data is parsed for relevant account-identifying details, and the account-based marketing platform 520 matches the lead to one of the accounts listed in the account store 542. In addition, the account-based marketing platform 520 maintains and updates account scores for each of the accounts in account store 542.

In some aspects, the trigger platform 530 provides a user interface to users of the automation management system 510 for manually adding, deleting, and editing triggers and trigger constraints. The trigger platform 530 user interface receives input from the user of the automation management system 510 that associates one or more marketing accounts with the triggers. In addition, the trigger platform 530 user interface receives configuration information regarding the format and recipients of alerts that are generated when the trigger constraints are satisfied. The trigger platform 530 stores the triggers, constraints, and other configuration details in a trigger store 514. When the trigger platform 530 determines that constraints for a trigger are satisfied, the trigger platform 530 can send alerts through network 550 to one or more email servers 564 or marketer devices 566.

Computer System

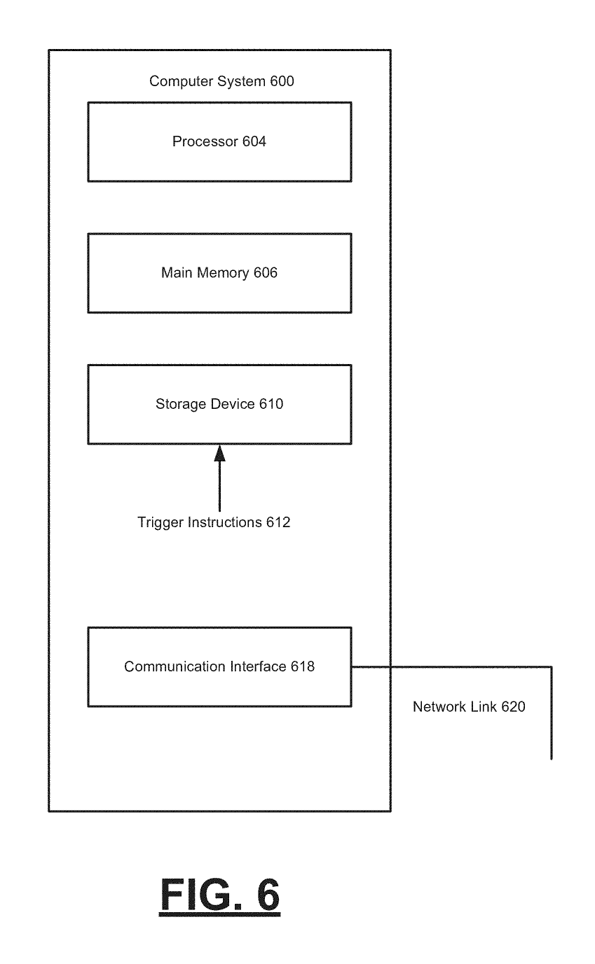

FIG. 6 is a block diagram that illustrates a computer system upon which aspects described herein may be implemented. For example, in the context of FIG. 1, system 100 may be implemented using one or more servers such as described by FIG. 6.

In an aspect, computer system 600 includes processor 604, memory 606 (including non-transitory memory), storage device 610, and communication interface 618. Computer system 600 includes at least one processor 604 for processing information. Computer system 600 also includes the main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) or other static storage device for storing static information and instructions for processor 604. The storage device 610, such as a magnetic disk or optical disk, is provided for storing information and instructions such as trigger instructions 612. The communication interface 618 may enable the computer system 600 to communicate with one or more networks through use of the network link 620 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

Examples described herein are related to the use of computer system 600 for implementing the techniques described herein. According to one aspect, those techniques are performed by computer system 600 in response to processor 604 executing one or more sequences of one or more instructions contained in main memory 606. Such instructions (e.g., trigger instructions 612) may be read into main memory 606 from another machine-readable medium, such as storage device 610. Execution of the sequences of instructions contained in main memory 606 causes processor 604 to perform the process steps described herein. In alternative aspects, hard-wired circuitry may be used in place of or in combination with software instructions to implement aspects described herein. Thus, aspects described are not limited to any specific combination of hardware circuitry and software.

Although illustrative aspects have been described in detail herein with reference to the accompanying drawings, variations to specific examples and details are encompassed by this disclosure. It is intended that the scope of examples described herein be defined by claims and their equivalents. Furthermore, it is contemplated that a particular feature described, either individually or as part of an aspect, can be combined with other individually described features, or parts of other aspects. Thus, absence of describing combinations should not preclude the inventor(s) from claiming rights to such combinations.

What is claimed is:

1. An automation management system comprising:
a memory resource to store instructions; and
one or more processors using the instructions stored in the memory resource to perform operations including:
monitoring a plurality of marketing channels for marketing activities performed by one or more leads;
determining that the one or more leads belong to a marketing account;
aggregating the marketing activities performed by the one or more leads across the plurality of marketing channels for the marketing account;
updating a plurality of account metrics for the marketing account based on the aggregated marketing activities;
based on the plurality of account metrics, determining that criteria for one or more predetermined account triggers are satisfied; and
transmitting an alert to at least a member of an account team associated with the marketing account.

2. The automation management system of claim 1, wherein the memory resource stores further instructions to perform operations including:
selecting content to display to the one or more leads based on determining that the criteria for the one or more predetermined account triggers are satisfied.

3. The automation management system of claim 1, wherein the marketing activities include a first activity on a first marketing channel and a second activity on a second marketing channel different from the first marketing channel.

4. The automation management system of claim 1, wherein the memory resource stores further instructions to perform operations including:
receiving one or more criteria for an account trigger from a user device of the member of the account team.

5. The automation management system of claim 1, wherein the marketing activities performed by the one or more leads occur during a programmed period of time.

6. The automation management system of claim 1, wherein the plurality of account metrics includes an account score for the marketing account.

7. The automation management system of claim 6, wherein the account score is updated based on the marketing activities performed by the one or more leads.

8. The automation management system of claim 6, wherein the criteria includes a change in the account score.

9. The automation management system of claim 1, wherein determining that the criteria for the one or more predetermined account triggers are satisfied is based on metrics for a plurality of accounts or an account segment.

10. The automation management system of claim 1, wherein the plurality of marketing channels includes traditional channels, such as live events, print media, and television, digital channels, such as websites, email, and mobile applications, and social media channels.

11. A method of account level triggering, the method being implemented by one or more processors and comprising:
monitoring a plurality of marketing channels for marketing activities performed by one or more leads;
determining that the one or more leads belong to a marketing account;
aggregating the marketing activities performed by the one or more leads across the plurality of marketing channels for the marketing account;
updating a plurality of account metrics for the marketing account based on the aggregated marketing activities;
based on the plurality of account metrics, determining that criteria for one or more predetermined account triggers are satisfied; and
transmitting an alert to at least a member of an account team associated with the marketing account.

12. The method of claim 11, further comprising:
selecting content to display to the one or more leads based on determining that the criteria for the one or more predetermined account triggers are satisfied.

13. The method of claim 11, wherein the marketing activities include a first activity on a first marketing channel and a second activity on a second marketing channel different from the first marketing channel.

14. The method of claim 11, further comprising:
receiving one or more criteria for an account trigger from a user device of the member of the account team.

15. The method of claim 11, wherein the marketing activities performed by the one or more leads occur during a programmed period of time.

16. The method of claim 11, wherein the plurality of account metrics includes an account score for the marketing account.

17. The method of claim 16, wherein the account score is updated based on the marketing activities performed by the one or more leads.

18. The method of claim 16, wherein the criteria includes a change in the account score.

19. The method of claim 11, wherein determining that the criteria for the one or more predetermined account triggers are satisfied is based on metrics for a plurality of accounts or an account segment.

20. A non-transitory computer-readable medium that stores instructions, executable by one or more processors, to cause the one or more processors to perform operations that comprise:
monitoring a plurality of marketing channels for marketing activities performed by one or more leads;
determining that the one or more leads belong to a marketing account;
aggregating the marketing activities performed by the one or more leads across the plurality of marketing channels for the marketing account;
updating a plurality of account metrics for the marketing account based on the aggregated marketing activities;
based on the plurality of account metrics, determining that criteria for one or more predetermined account triggers are satisfied; and
transmitting an alert to at least a member of an account team associated with the marketing account.
